(19) United States
(12) Patent Application Publication
(10) Pub. No.: US 2019/0077680 A1
(43) Pub. Date: Mar. 14, 2019

(54) CARBON BLOCK FILTER FOR REMOVAL OF CESIUM AND METHOD OF MANUFACTURING SAME

(71) Applicants: PICOGRAM CO., LTD., Incheon (KR); KOREA ATOMIC ENERGY RESEARCH INSTITUTE, Daejeon (KR)

(72) Inventors: Sung Taek LIM, Gimpo-si (KR); Hyun Ki HONG, Incheon (KR); Mi Lim BYUN, Incheon (KR); Chang Hyun ROH, Daejeon (KR)

(73) Assignees: PICOGRAM CO., LTD., Incheon (KR); KOREA ATOMIC ENERGY RESEARCH INSTITUTE, Daejeon (KR)

(21) Appl. No.: 16/124,599

(22) Filed: Sep. 7, 2018

(30) Foreign Application Priority Data
Sep. 11, 2017 (KR) 10-2017-0115925

(51) Int. Cl. C02F 1/28; B01J 20/20; B01J 20/28; B01J 20/26; B01J 20/30; B01J 39/02; B01J 39/09

(52) U.S. Cl. CPC C02F 1/28; B01J 20/20; B01J 20/2803; B01J 20/261; B01J 20/3007; C02F 2101/12; B01J 20/3042; B01J 20/3078; B01J 39/02; B01J 39/09; B01J 20/3035

(57) ABSTRACT

The present invention relates to a carbon block filter for removal of cesium and a method of manufacturing the same. The carbon block includes activated carbon, a binder, and a cesium adsorbent, and is manufactured in which the activated carbon, the binder, and the cesium adsorbent are mixed, heated, and molded or the activated carbon, the binder, and the cesium adsorbent are mixed, molded, and heated. The carbon block filter manufactured thereby removes cesium excellently and maintains water purification performance for long periods of time.

### CROSS-REFERENCE TO RELATED APPLICATIONS

The present application claims priority to Korean Patent Application No. 10-2017-0115925, filed Sep. 11, 2017, the entire contents of which is incorporated herein for all purposes by this reference.

### FIELD

The present invention relates to a carbon block filter for removal of cesium and a method of manufacturing the same. More particularly, the present invention relates to a carbon block filter for removal of cesium and a method of manufacturing the same, the carbon block filter removing cesium excellently and maintaining water purification performance for long periods of time.

### BACKGROUND

Generally, a filter mounted on a water purifier has functions such as filtration of various impurities such as iron, rust, and organic substances contained in tap water, sterilization of bacteria, and inactivation of viruses.

Various types of filters have been proposed, and specifically, a carbon block filter has a built-in carbon block in a filter container so that water can be purified while passing through the carbon block. In the conventional method of manufacturing the carbon block filter, the carbon block filter is manufactured by a compression pressing process or an extruding process using powdered activated carbon and a general PE binder as main raw materials.

The conventional carbon block filter manufactured according to the above process is required to be larger than necessary in order to improve the water purification performance, leading to an increase in volume thereof whereby inconvenience in handling is caused and the volume of the entire water purifier is increased.

In addition, in the case of the conventional carbon block filter, there is a problem in that the effect of filtering out impurities such as cesium is insufficient, although the filter has excellent performance to filter out impurities such as iron, rust, and organic substances contained in tap water.

### SUMMARY

Accordingly, the present invention has been made keeping in mind the above problems occurring in the related art, and an object of the present invention is to propose a carbon block filter for removal of cesium and a method of manufacturing the same, the carbon bock filter removing cesium excellently and maintaining purification performance for long periods of time.

In order to achieve the above object, the present invention provides a carbon block filter for removal of cesium, the filter including activated carbon, a binder, and a cesium adsorbent.

The filter may include 100 parts by weight of the activated carbon; 10 to 100 parts by weight of the binder; and 1 to 60 parts by weight of the cesium adsorbent.

The binder may be at least one material selected from the group consisting of polypropylene, low-density polyethylene, high-density polyethylene, and ultra-high-molecular-weight polyethylene.

The cesium adsorbent may be composed of Prussian blue.

In addition, in order to achieve the above object, the present invention provides a method of manufacturing a carbon block filter for removal of cesium, the method including: preparing a mixture in which 100 parts by weight of activated carbon, 10 to 100 parts by weight of a binder, and 1 to 60 parts by weight of a cesium adsorbent are mixed; heating the mixture prepared at the preparing to a temperature ranging from 100° C. to 300° C. for 20 minutes to 60 minutes; and compress-molding the mixture heat-treated at the heating to a pressure ranging from 2 kgf/cm² to 6 kgf/cm².

Furthermore, in order to achieve the above object, the present invention provides a method of manufacturing a carbon block filter for removal of cesium, the method including: preparing a mixture in which 100 parts by weight of activated carbon, 10 to 100 parts by weight of a binder, and 1 to 60 parts by weight of a cesium adsorbent are mixed; compress-molding the mixture prepared at the preparing to a pressure ranging from 2 kgf/cm² to 6 kgf/cm²; and heating the mixture compress-molded at the compress-molding to a temperature ranging from 100° C. to 300° C. for 20 minutes to 60 minutes.

According to the carbon block filter for removal of cesium as described above and the method of manufacturing the same, the carbon block filter removes cesium excellently and maintains water purification performance for long periods of time.

### DRAWINGS

The above and other objects, features, and other advantages of the present invention will be more clearly understood from the following detailed description when taken in conjunction with the accompanying drawings, in which:

FIG. 1 is a flowchart illustrating a method of manufacturing a carbon block filter for removal of cesium according to an embodiment of the present invention;

FIG. 2 is a flowchart illustrating a method of manufacturing a carbon block filter for removal of cesium according to another embodiment of the present invention;

FIG. 3 is a schematic view illustrating that Prussian blue adsorbs cesium, the Prussian blue contained in the carbon block filter for removal of cesium according to the present invention;

FIGS. 4 to 8 are graphs illustrating cesium removal performance of carbon block filters respectively prepared in Example 1 and Comparative Example 1 of the present invention; and

FIG. 9 is a photograph illustrating the carbon block filter prepared in Example 1 of the present invention.

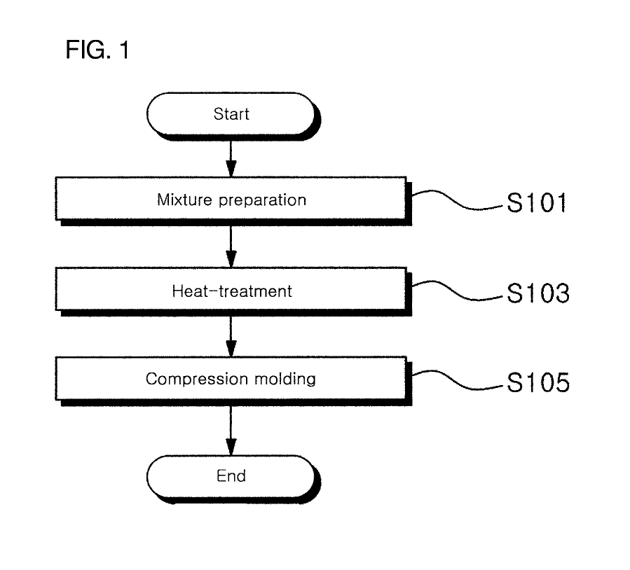

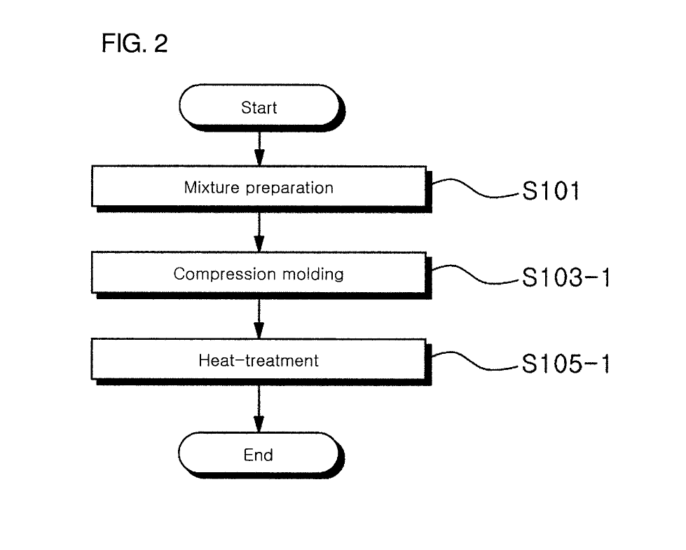

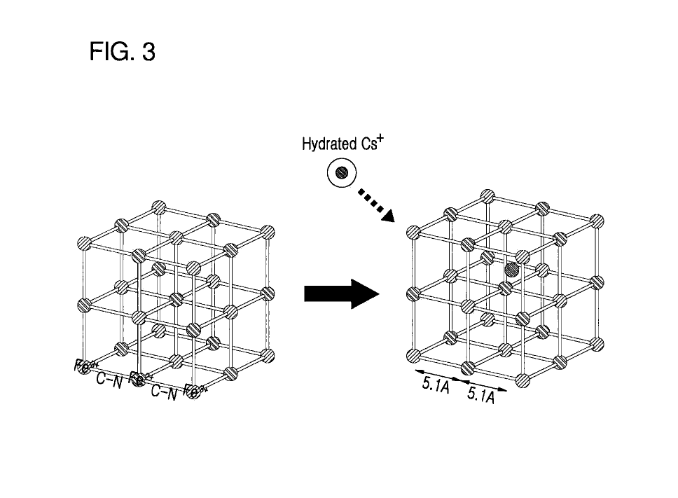

### DETAILED DESCRIPTION

Hereinbelow, preferred embodiments of the present invention will be described in detail with reference to the accompanying drawings. The invention is intended to be easily embodied by one of ordinary skill in the art to which this invention belongs, and is not meant to limit the spirit and scope of the invention.

A carbon block filter for removal of cesium of the present invention includes activated carbon, a binder, and a cesium adsorbent. The carbon block filter for removal of cesium may include: 100 parts by weight of the activated carbon; 10 to 100 parts by weight of the binder; and 1 to 60 parts by weight of the cesium adsorbent.

The activated carbon is a main raw material of the carbon block filter for removal of cesium of the present invention. The activated carbon may be used in a form of powder or fiber and, more preferably, in a form of a mixture of powdered activated carbon and fibrous activated carbon.

The powdered activated carbon removes chlorine components, odors, volatile organic compounds, and certain heavy metals in water and improves the taste of purified water. The fibrous activated carbon has better water purification performance and adsorption performance than general granular activated carbon and powder activated carbon, and maintains the water purification performance for long periods of time even for a large amount of water.

The binder is contained in the carbon block filter by 10 to 100 parts by weight and binds the components constituting the carbon block filter for removal of cesium. When the binder is composed of a porous material having a large molecular weight with absence of hydrogen, the binder serves to bind the components described above without deteriorating performances of the activated carbon and the cesium adsorbent.

The binder may be at least one material selected from the group consisting of polypropylene, low-density polyethylene, high-density polyethylene, and ultra-high-molecular-weight polyethylene.

Here, it is more preferable that the binder is composed of ultra-high-molecular-weight polyethylene. When ultra-high-molecular-weight polyethylene is applied as the binder as described above, the filter is improved in impact resistance, abrasion resistance, slipperiness, and chemical resistance such that the filter exhibits excellent durability. Thus, a filter can be provided which maintains the water purification performance for long periods of time.

Specifically, as the ultra-high-molecular-weight polyethylene, it is preferable to use GUR produced by Ticona GmbH, Germany, wherein the GUR has a molecular weight of about 300 to 1000.

When the content of the binder is less than 10 parts by weight, the above-mentioned effects are insignificant and the durability of the carbon block filter may be deteriorated. On the other hand, when the content of the binder exceeds 100 parts by weight, the durability of the filter is not greatly improved but the water purification performance is lowered.

The cesium adsorbent is contained in the carbon block filter by 1 to 60 parts by weight and serves to impart cesium adsorption performance to the carbon block filter for removal of cesium of the present invention. The cesium adsorbent may be composed of Prussian blue.

The Prussian blue falls into two types depending on the solubility in water. In general, the Prussian blue is formed by a combination of Fe³⁺ and [Fe^{II}(CN)₆]⁴⁻ or a combination of Fe²⁺ and [Fe^{III}(CN)₆]³⁻.

Typically, insoluble Prussian blue is represented by Fe^{III}₄[Fe^{II}(CN)₆]₃ and soluble Prussian blue is represented by KFe^{III}[Fe^{II}(CN)₆]. Each formation process of the two types of Prussian blue is shown in following Reaction Equations 1 and 2, respectively.

4Fe³⁺+3[Fe^{II}(CN)₆]⁴⁻→Fe₄^{III}[Fe^{II}(CN)₆]₃ Reaction Equation 1

K⁺+Fe³⁺+[Fe ^{II}(CN)6]⁴⁻→KFe^{III}[Fe^{II}(CN)₆] Reaction Equation 2

The adsorption performance of Prussian blue for alkali metal ions is related to Stokes radii of the alkali metal ions as hydrated ions, where the adsorption performance of Prussian blue for alkali metal ions is exhibited in the order of Cs+»K+≥Na+. This is because Prussian blue exhibits high adsorption performance with an ion among the alkali metal ions, the ion having a Stokes radius fitted in Prussian blue lattice spaces. The Stokes radii of the alkali ions are Cs+(1.19)<K+(1.25)<Na+(1.84 Å) and the smallest Stokes radius of Cs+ is fitted well and trapped in Prussian blue lattice spaces in size. Accordingly, the cesium adsorbent composed of Prussian blue serves to selectively adsorb cesium.

In addition, the Prussian blue lattice is filled with coordination water molecules to form hydrophilic spaces. Hydrated Cs+ ions prefer to be adsorbed in such hydrophilic spaces of Prussian blue. When Cs+ ions occupy the hydrophilic spaces, Cs+ ions are efficiently adsorbed by proton-exchange mechanism of coordination water molecule of Fe(III), which is shown in the following Reaction Equation 3:

Fe^{III}—OH₂+Cs⁺A⁻→{Fe^{III}—OH}⁻Cs⁺+H⁺A⁻

Accordingly, as shown in Reaction Equation 3, Cs+ ions are effectively adsorbed in Prussian blue lattice spaces by proton-exchange.

In addition, insoluble Prussian blue shown in the above Reaction Equation 1 is suitable as a cesium adsorbent because insoluble Prussian blue can be easily recovered through a recovery process.

When the content of the cesium adsorbent is less than 1 part by weight, the above-mentioned effects are insignificant. On the other hand, when the content of the cesium adsorbent exceeds 60 parts by weight, the contents of the activated carbon and the binder are relatively reduced, leading to deterioration of the water purification performance and the durability of the filter.

A method of manufacturing a carbon block filter for removal of cesium according to an embodiment of the present invention includes: preparing a mixture (S101) in which 100 parts by weight of activated carbon, 10 to 100 parts by weight of a binder, and 1 to 60 parts by weight of a cesium adsorbent are mixed; heating the mixture prepared at the preparing step S101 to a temperature ranging from 100° C. to 300° C. for 20 minutes to 60 minutes (S103); and compress-molding the mixture heat-treated at the heating step S103 to a pressure ranging from 2 kgf/cm² to 6 kgf/cm² (S105).

At the preparing step S101, the activated carbon, the binder, and the cesium adsorbent are mixed together. Specifically, with use of a precision digital scale (CB-3000), 100 parts by weight of the activated carbon, 10 to 100 parts by weight of the binder, and 1 to 60 parts by weight of the cesium adsorbent are mixed, and the mixture is prepared by using a ribbon blender for 10 minutes to 20 minutes.

Here, the components and roles of the activated carbon, the binder, and the cesium adsorbent are the same as those described in the carbon block filter for removal of cesium, and thus a description thereof will be omitted.

At the heating step S103, the mixture obtained from the preparing step S101 is heated at a temperature ranging from 100° C. to 300° C. for 20 minutes to 60 minutes. After the heating step S103, moisture and various impurities contained in the mixture prepared obtained from the preparing step S101 are removed.

At the compress-molding step S105, the mixture heat-treated at the heating step S103 to a pressure ranging from 2 kgf/cm² to 6 kgf/cm². The mixture heat-treated at the heating step S103 is transferred to a compression molding block, bound to a compression molding machine, and compressed at a pressure of 2 kgf/cm² to 6 kgf/cm² for 8 seconds to 12 seconds. Here, the carbon block filter may be prepared through extrusion molding instead of the compress-molding step S103.

After the compress-molding step S105 including the above-described process, a molded article of a cylindrical carbon block filter is produced.

On the other hand, a method of manufacturing a carbon block filter for removal of cesium according to another embodiment of the present invention includes: preparing a mixture (S101) in which 100 parts by weight of activated carbon, 10 to 100 parts by weight of a binder, and 1 to 60 parts by weight of a cesium adsorbent are mixed; compress-molding the mixture prepared at the preparing step S101 to a pressure ranging from 2 kgf/cm² to 6 kgf/cm² (S103-1); and heating the mixture compress-molded at the compress-molding step S103-1 to a temperature ranging from 100° C. to 300° C. for 20 minutes to 60 minutes (S105-1).

Here, the specific conditions of the preparing step S101, the compress-molding step S103-1, and the heating step S105-1 are the same as the preparing step S101, the heating step S103, and the compress-molding step S105 which are described above, and thus a description thereof will be omitted.

Hereinafter, the method of manufacturing the carbon block filter for removal of cesium according to the present invention and physical properties of the carbon block filter for removal of cesium manufactured by the method will be described by way of examples.

### EXAMPLE 1

750 g of activated carbon, 150 g of binder (high-density polyethylene), and 100 g of Prussian blue (insoluble Iron^{III} ferrocyanide from Sigma-Aldrich Company) were weighed using a precision digital scale (CB-3000), put into a 1000 ml beaker, and mixed for 15 minutes using a ribbon blender. The mixture was placed in a laboratory heater maintained at a temperature of 130° C. and heated for 30 minutes. The heat-treated mixture was transferred to a compression molding block, bound to a compression molding machine and compressed at a pressure of 2.5 kgf/cm² for 10 seconds such that a carbon block filter for removal of cesium was prepared.

### COMPARATIVE EXAMPLE 1

A carbon block filter was prepared using 850 g of activated carbon and 150 g of binder in the same manner as in Example 1.

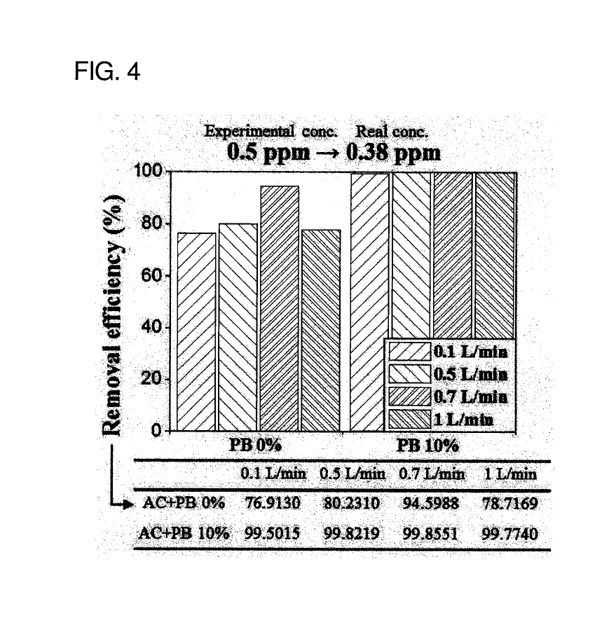

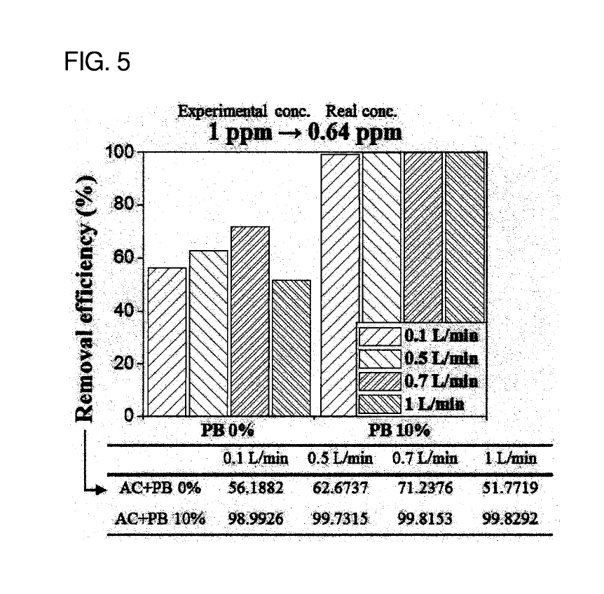

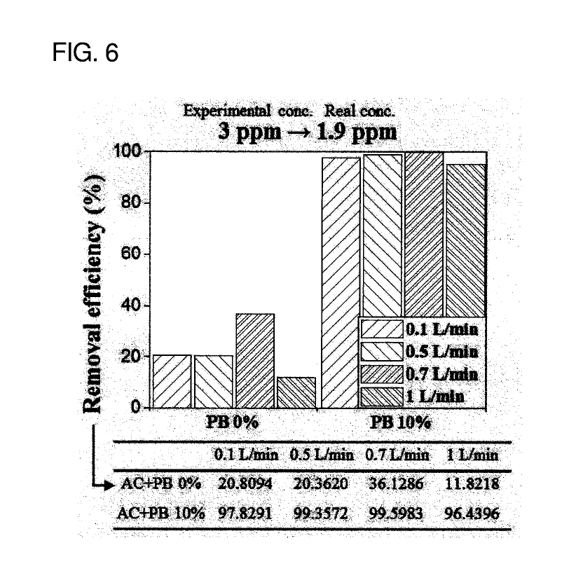

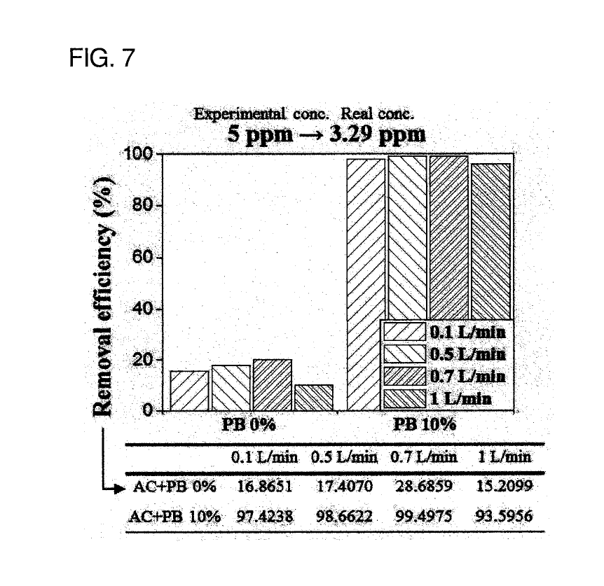

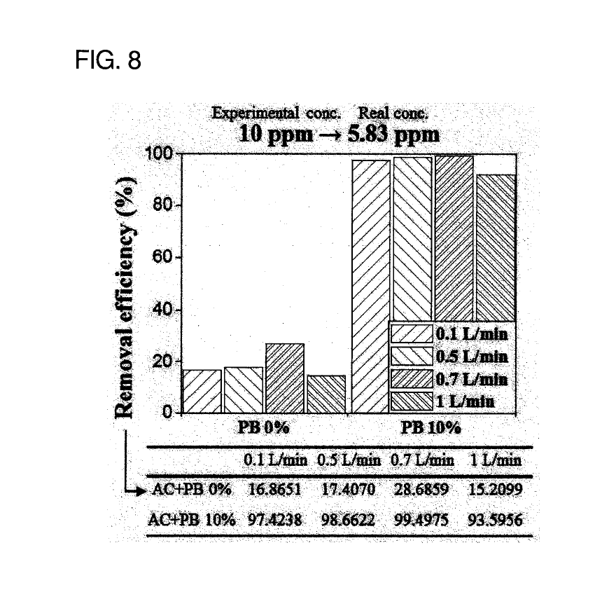

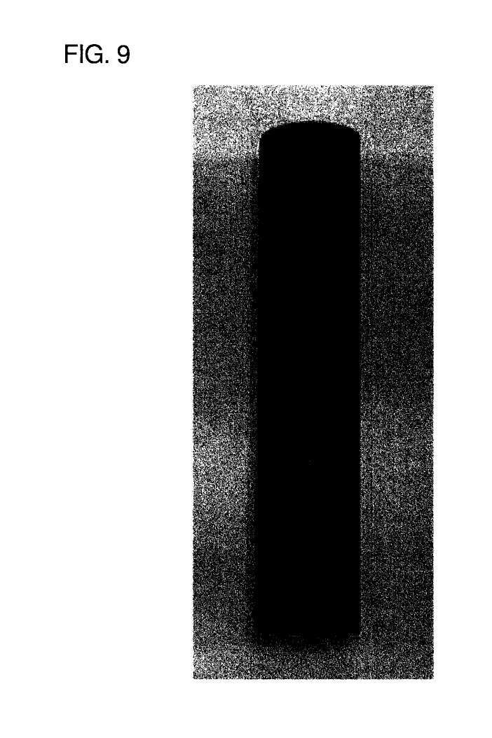

Cesium removal performance of the carbon block filter for removal of cesium prepared in Example 1 and of the carbon block filter prepared in Comparative Example 1 was measured and shown in FIGS. 4 to 8.

A solution was prepared by dissolving cesium nitrate (Sigma-Aldrich Company) in distilled water. The cesium removal performance of the filter was prepared under conditions of cesium concentration (0.5 ppm, 1 ppm, 3 ppm, 5 ppm, and 10 ppm) of the solution because a separate process test for the cesium removal efficiency of the filter was not designated. In order to evaluate the performance of the filter according to a flow rate of inflow water, flow rate conditions were 0.1 L/min, 0.5 L/min, 0.7 L/min, and 1 L/min.

In addition, the solution was introduced into a tank of a performance tester and passed through the performance tester with the carbon block filter of Example 1 and Comparative Example 1, respectively. Cesium removal performance of the purified water undergoing the different conditions was checked out by ICP analysis.

As shown in FIGS. 4 to 8, the carbon block filter for removal of cesium prepared according to Example 1 of the present invention removed cesium excellently as compared to the carbon block filter prepared according to Comparative Example 1.

Accordingly, the carbon block filter for removal of cesium of the present invention and the method of manufacturing the same provide a carbon block filter that removes cesium excellently and maintains water purification performance for long periods of time.

What is claimed is:

1. A carbon block filter for removal of cesium, the filter comprising activated carbon, a binder, and a cesium adsorbent.

2. The filter of claim 1, comprising:
100 parts by weight of the activated carbon; 10 to 100 parts by weight of the binder; and 1 to 60 parts by weight of the cesium adsorbent.

3. The filter of claim 1, wherein the binder is at least one material selected from the group consisting of polypropylene, low-density polyethylene, high-density polyethylene, and ultra-high-molecular-weight polyethylene.

4. The filter of claim 1, wherein the cesium adsorbent is composed of Prussian blue.

5. A method of manufacturing a carbon block filter for removal of cesium, the method comprising:
preparing a mixture in which 100 parts by weight of activated carbon, 10 to 100 parts by weight of a binder, and 1 to 60 parts by weight of a cesium adsorbent are mixed;
heating the mixture prepared at the preparing to a temperature ranging from 100° C. to 300° C. for 20 minutes to 60 minutes; and
compress-molding the mixture heat-treated at the heating to a pressure ranging from 2 kgf/cm² to 6 kgf/cm².

6. A method of manufacturing a carbon block filter for removal of cesium, the method comprising:
preparing a mixture in which 100 parts by weight of activated carbon, 10 to 100 parts by weight of a binder, and 1 to 60 parts by weight of a cesium adsorbent are mixed;
compress-molding the mixture prepared at the preparing to a pressure ranging from 2 kgf/cm² to 6 kgf/cm²; and
heating the mixture compress-molded at the compress-molding to a temperature ranging from 100° C. to 300° C. for 20 minutes to 60 minutes.

7. The filter of claim 2, wherein the binder is at least one material selected from the group consisting of polypropylene, low-density polyethylene, high-density polyethylene, and ultra-high-molecular-weight polyethylene.

8. The filter of claim 2, wherein the cesium adsorbent is composed of Prussian blue.
